(19) United States
(12) Patent Application Publication
(10) Pub. No.: US 2023/0141196 A1
(43) Pub. Date: May 11, 2023

(54) EMISSIONS CONTROL FOR AN ENGINE SYSTEM

(71) Applicant: Transportation IP Holdings, LLC, Norwalk, CT (US)

(72) Inventors: Matthew Hart, Erie, PA (US); James Robert Mischler, Lawrence Park, PA (US); Robert Alton, Erie, PA (US); Joseph Audu Ishaku, Erie, PA (US)

(21) Appl. No.: 17/454,190

(22) Filed: Nov. 9, 2021

(51) Int. Cl. F02D 41/38; F02D 41/00; B61C 5/00

(52) U.S. Cl. CPC F02D 41/3827; F02D 41/0007; B61C 5/00; F02D 2200/04; F02D 2200/0614

(57) ABSTRACT

A method is provided for controlling an engine. In one example, the method may include injecting fuel to the engine; and during an operating condition, limiting injected fuel based on engine airflow to a smoke-fuel limit, the smoke-fuel limit transiently adjusted from a first smoke-fuel limit to a second smoke-fuel limit based on a duration operating at the smoke-fuel limit. In one example, the method may include during another operating condition, fuel injection not limited by the smoke-fuel limit. In some examples, the duration may be a time duration. In some examples, the duration may be a crank angle duration. In some examples, limiting the injected fuel is based on an estimated engine airflow and estimated fuel injection amount to the engine.

### BACKGROUND

### Technical Field

Embodiments of the subject matter disclosed herein relate to systems and methods for control of emissions.

### DISCUSSION OF ART

Vehicles using combustion power sources, such as diesel internal combustion engines, may limit the amount of exhaust opacity emissions emitted from engines. Engines may include controls over the amount of fuel entering the engine cylinder for a given amount of air during a combustion cycle. Engine load rate and ready-to-serve capability are impacted by the amount of fuel to the cylinder.

Strategies to manage engine torque and exhaust opacity emissions may include limiting a maximum smoke-fuel ratio. For example, the torque applied to an engine by the alternator for a given combination of speed, power, acceleration, and ambient conditions may be empirically calibrated. An airflow model may predict, based on sensed & calibrated inputs, the air mass ingested into the engine cylinder during the intake stroke, and limit the amount of fuel mass, again modeled through sensed and calibrated inputs, injected into the cylinder during combustion. A smoke-fuel limit can then be calibrated to not allow the engine to exceed a specific exhaust opacity over a range of engine speed and torque combinations. Empirical engine calibration may require redesign and validation when an engine is utilized in another application with a different torque application signature. Smoke-fuel limits may be calibrated to a single engine condition at a given time, and as conditions change, the engine may not be able to maintain torque. Variations between modeled and actual air and fuel flows in the cylinder may affect torque and load rate on a healthy engine. Further, modeled versus actual variations may increase over the lifetime of the engine. It may be desirable to have a strategy to manage engine torque and exhaust opacity emissions that differs in function from those that are currently available.

### BRIEF DESCRIPTION

In one embodiment a method for controlling an engine may include injecting fuel to the engine; and during at least an operating condition, limiting injected fuel based on engine airflow to a smoke-fuel limit, the smoke-fuel limit transiently adjusted from a first smoke-fuel limit to a second smoke-fuel limit based on a duration operating at the smoke-fuel limit.

### BRIEF DESCRIPTION OF THE DRAWINGS

FIG. 1 shows a schematic diagram of an engine having opacity emission control features.

FIG. 2 shows a schematic of a strategy for managing opacity emissions and torque in an engine.

FIG. 3 shows a flowchart of an example use of the strategy in FIG. 2.

### DETAILED DESCRIPTION

Embodiments of the invention are disclosed in the following description and may relate to an internal combustion engine system managing control of opacity emissions. Such an engine system may be positioned in a non-stationary (e.g., vehicle) system or may be part of a stationary (e.g., generator) system. Suitable engine systems may manage control for opacity emissions by employing a calibrated smoke-fuel limit based on an estimate of air density and fuel ingestion, optionally for a given engine speed and load condition. Aspects of the invention may reduce errors in smoke-fuel ratio limit calibration resulting from incomplete or inaccurate knowledge of the engine system. In examples where an engine system manages control for opacity emissions by limiting the amount of fuel that can be injected given an estimate of airflow, variation in knowledge of actual fuel injection and actual air ingestion may lead to less than desirable engine performance, especially in transient conditions. In examples where the smoke-fuel limit is maintained too low even during transient conditions, the engine may be restricted to meet emission standards that do not apply to the system and/or are based on inaccurate readings of operating conditions. A smoke control strategy that allows operational control of a dynamically adjusted smoke-fuel limit that does not overly restrict the ability of the engine to move past conditions that are causing the engine to be at the limit may reduce the impact of variation in knowledge about the engine system.

A technical effect for introducing operational control for a dynamically adjustable smoke-fuel limit is adding flexibility to a fuel injection limit calibration while allowing an engine to meet acceptable load rate for field service applications to achieve desirable/expected performance and overcome uncertainty in estimated fuel injection amount and/or estimated engine airflow calculations and/or measurements. In one embodiment, a second smoke-fuel limit may be determined in real-time during engine operation in parallel with a first smoke-fuel limit to allow the engine to transiently operate a higher smoke-fuel limit, with the operational control between the first and second smoke-fuel limits based on engine operation conditions, including torque demand, speed, ambient conditions, and duration of operation at a given combination of these conditions. The second smoke-fuel limit may be tuned such that in a separate combination of the aforementioned conditions it allows the engine to achieve desired/expected fuel injection, while still maintaining overall exhaust opacity emissions less than a threshold opacity (e.g. an average 10% opacity over 6 minutes). For example, the second smoke-fuel limit may temporarily allow the engine to move past conditions in which uncertainty in measured engine intake air and/or delivered fuel are artificially causing the engine to hit the first smoke-limit, which in turn limits fuel, and may allow the engine to transition to another operating condition. For example, temporary relief in fuel limiting to the second smoke-fuel limit may enable temporarily increased engine torque. Increased engine torque may allow the engine speed and/or turbocharger speed to increase to a level where there is sufficient engine airflow so that neither the first nor the second smoke-limit is limiting fuel injection. This may reduce the chance that the engine is held in a speed condition or a turbocharger condition in which the fuel is smoke-limited (and the engine is thus unable to exit said limiting conditions).

In one example, improved performance with the approach described herein may be achieved when including a bleeding mechanism in the transition among one or more smoke-fuel limits in the engine control system. The bleeding mechanism may include accessing a look-up table that compares the ratio of the modeled fuel flow to the upper limit of fuel flow, based on the current operating condition modeled airflow and upper smoke-fuel ratio limit. If the modeled fuel flow is within a threshold range of the upper limit of fuel flow, the upper limit gradually bleeds toward the secondary upper limit to allow the engine to increase fueling.

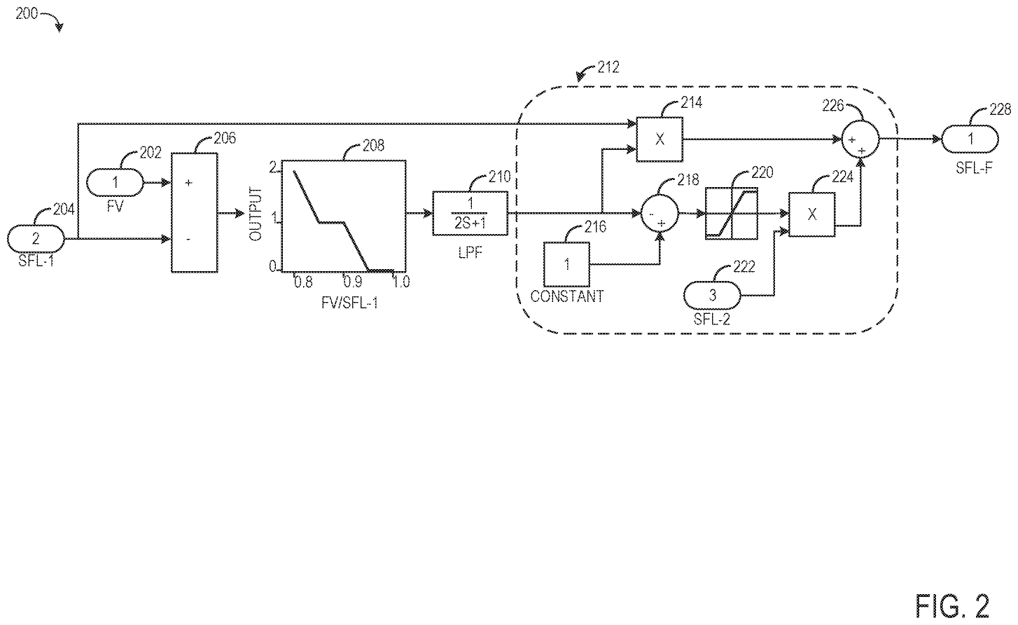

In an example, the bleeding is provided so that the transition among different smoke-fuel limits is quick enough to provide acceptable torque/load rate performance, but slow enough that the engine is not operated with excessive amounts of fuel before in-cylinder conditions are appropriate to meet desired smoke opacity conditions, for example at an exhaust stack downstream of the engine. If the engine's modeled fuel flow is not close to the upper limit of fuel flow, then the bleeding mechanism is not active in order to maintain control on smoke opacity. This bleeding provides for introduction of real-time control based on a duration (at a specific torque demand, speed, and ambient condition) and the value/rate of change between the first to second smoke-fuel limits. In an example, the duration may be a time duration, such as described in FIG. 2. In another example, the duration may be a crank-angle duration, where the control system operates in the crank-angle domain in real-time, rather than the time domain.

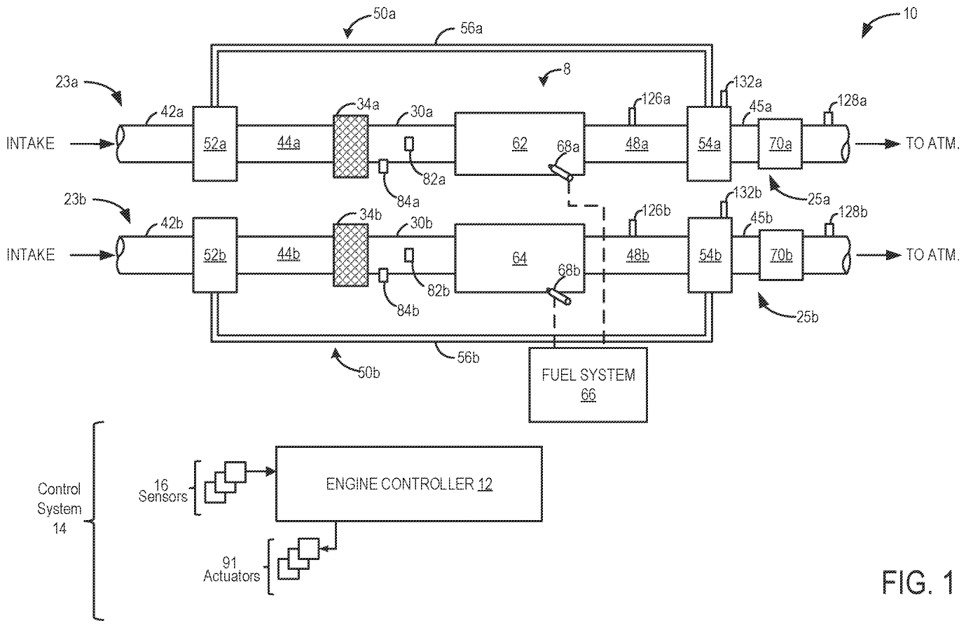

FIG. 1 shows an embodiment of a system in which a smoke control strategy may be used. Specifically, FIG. 1 depicts an engine system 10 that may be included in a vehicle or vehicle system, such as a locomotive. Alternatively, it may be included in an automotive vehicle or a stationary power generation system. In an example, the engine system may be a split engine system with the engine split into two banks, such as in a V-engine configuration. However, other engine configurations may be used.

Engine system 10 may include a split engine 8 with a first bank of cylinders 62 and a second bank of cylinders 64. In this example, the engine may be a diesel-fueled internal combustion engine. In embodiments, the engine may be a single, dual, or multi-fuel engine. For example, the engine may combust a mixture of gaseous fuel and air upon injection of diesel fuel during compression of the air-gaseous fuel mixture. In other non-limiting embodiments, the engine may additionally combust fuel including gasoline, kerosene, natural gas, biodiesel, bio fuel, or other petroleum distillates of similar density through compression ignition (and/or spark ignition). In an example, the engine may combust an injected fuel or fuel mixture, such as diesel, ammonia, or any of the above-mentioned fuels, and/or combinations thereof.

The engine includes a first intake system 23a and a second intake system 23b independent of each other. A first intake passage 42a leading to a first intake manifold 44a and a first intake 30a may be coupled to the first bank of cylinders. A second intake passage 42b leading to a second intake manifold 44b and a second intake 30b may be coupled to the second bank of cylinders. The engine may also include a first engine exhaust system 25a and a second engine exhaust system 25b independent of each other. The first bank of cylinders may be coupled to a first exhaust manifold 48a leading to a first exhaust passage 45a and the second bank may be coupled to a second exhaust manifold 48b leading to a second exhaust passage 45b that routes exhaust gas to the atmosphere. Each of the first exhaust passage and second exhaust passage may include one or more emission control devices 70a and 70b respectively, which may be mounted in a close-coupled position in the respective exhaust passage. One or more emission control devices may include a three-way catalyst, lean NOx trap, oxidation catalyst, etc.

The engine may further include a pair of boosting devices, such as a first turbocharger 50a, including a first compressor 52a arranged along first intake passage and a second turbocharger 50b, including a second compressor 52b arranged along second intake passage. The first compressor may be at least partially driven by a first turbine 54a arranged along first exhaust passage, via a first shaft 56a and the second compressor may be at least partially driven by a second turbine 54b arranged along the second exhaust passage, via a second shaft 56b. In alternate embodiments, the boosting devices may be a supercharger, wherein compressors may be at least partially driven by the engine and/or an electric machine, and may not include a corresponding turbine.

The first turbocharger and the second turbocharger may operate independent of each other to provide boost pressure to the first bank of cylinders and second bank of cylinders, respectively. Compressed air from the first compressor may be directed to the first bank via a first intercooler 34a housed in the first intake to reduce the temperature of the boosted air charge supplied to the first bank of cylinders. Compressed air from the second compressor may be directed to the second bank of cylinders via a second intercooler 34b housed in the second intake to reduce the temperature of the boosted air charge supplied to the second bank of cylinders.

A first intake manifold air temperature (MAT) sensor 82a and a first intake manifold air pressure (MAP) sensor 84a may be positioned downstream of first intercooler in first intake to estimate a first temperature and first pressure, respectively, of intake air supplied to first bank of cylinders. A second MAT sensor 82b and a second MAP sensor 84b may be positioned downstream of second intercooler in second intake to estimate a second temperature and second pressure, respectively, of intake air supplied to second bank of cylinders. A first pre-turbine temperature sensor 126a may be positioned upstream of first turbine in first exhaust manifold and a second pre-turbine temperature sensor 126b may be positioned upstream of second turbine in second exhaust manifold. The first turbine may include a first turbine speed sensor 132a and the second turbine may include a second turbine speed sensor 132b.

A fuel system 66 may supply fuel to each of the first bank and the second bank of cylinders via fuel injectors to each cylinder in each bank. The fuel system may include a common rail fuel injection system with a one/two high-pressure fuel pumps and corresponding inlet metering valve. In this example, a first injector 68a is shown to supply fuel to a cylinder in the first bank and a second injector 68b is shown to supply fuel to another cylinder in the second bank. Each cylinder in each of the first bank and the second bank may be coupled to a fuel injector. As an example, in an engine including 16 cylinders (divided in two banks), the fuel system may include 16 fuel injectors with each injector coupled to a distinct cylinder.

The engine may be controlled at least partially by control system 14 including engine controller 12 and by input from a vehicle operator via an input device (not shown). The engine controller is shown receiving information from a plurality of engine sensors 16 (various examples of which are described herein) and sending control signals to a plurality of engine actuators 91 (various examples of which are described herein, including the fuel injectors). As one example, engine sensors may include pre-turbine temperature sensors, exhaust temperature sensors 128a, 128b located downstream of emission control devices, MAP sensors 84a and 84b, and MAT sensors 82a and 82b. Various other sensors such as additional pressure, temperature, air/fuel ratio and composition sensors may be coupled to various locations in the engine system. As another example, engine actuators may include the fuel injectors of the fueling system, and throttles, if equipped. Other actuators, such as a variety of additional valves, turbocharger wastegates, turbocharger variable nozzle vanes, etc., may be coupled to various locations in the engine system. The engine controller may receive input data from the various engine sensors, process the input data, and trigger the engine actuators in response to the processed input data based on instruction or code programmed therein corresponding to one or more methods.

Under some operating conditions, there may be a tension between balancing control of opacity emissions while allowing an engine to meet acceptable load rate. Limiting the amount of fuel to an engine based on an estimate of fuel consumption and engine airflow as a way to limit opacity emissions, such as smoke emissions, may be hindered by incomplete or inaccurate system knowledge. For example, there may be substantial variation, at least during some conditions, in knowledge or estimates of fuel injection and/or air ingestion from actual values. In particular, controlling opacity emissions by limiting fuel injection based on a maximum allowable fuel/air limit may be most apparent in transient conditions such as during turbocharger spooling. An engine can become stuck in a low torque state because the calculated smoke-fuel limit limits the injection of fuel sufficient to ramp the turbocharger to a condition where is it able to generate sufficient boost to increase airflow. With fuel limited in this way, the engine may be physically capable of combusting more fuel but cannot due to the limited fuel injection. This fuel limit, even if optimized for the current engine conditions, may not be able to maintain torque at all ambient conditions encountered during operation. Further, errors in smoke-fuel limit calculations may occur for example, due to pressure loss and/or fuel leakage in the fuel system. There may be competing wear mechanisms in certain systems, such as in the fuel system and fuel pump, which may be sources of limit calculation error. Also, or additionally, fluctuations in ambient conditions, such as altitude or temperature, may lead to off-calculations. An input to the smoke-fuel limit calibration that results in variation in how much actual fuel is injected and/or how much air is ingested may introduce errors that could lead to suboptimal engine performance if the smoke-fuel limit overly limits fuel injection in a way that the engine is unable to move away from the current conditions (e.g., engine speed and turbocharger speed) such that the engine becomes stuck in a fuel-limited (due to smoke limiting) state for a given set of operating conditions.

The schematic of FIG. 2 describes a smoke control strategy 200 to address the above-identified issues. In one example, the strategy herein may enable an engine to control allowable exhaust opacity emissions while temporarily increasing engine torque and speed at a defined rate to navigate away from conditions that may otherwise cause the engine to be stuck in a fuel-limited condition.

In an embodiment, to separate out the variability in system knowledge, the control system includes a time-based adjustment. This is achieved by injecting fuel based on a first transient smoke-fuel limit and then monitoring the margin of fuel demand during transient conditions. A healthy engine should sit against the first fuel limit transiently and spool up. If airflow spools slowly it may indicate that the system is degraded, and therefore the opacity emission standard may not apply, or it may indicate there is little risk of smoke because the system is not actually at a low air-fuel ratio but rather the control system's estimate of air ingestion, or fuel injection, or both, is substantially degraded. In either case, the smoke control strategy includes a second, less fuel-restrictive, long transient smoke-fuel limit that allows increased fuel injection and determination of the rate over which to bring first transient smoke-fuel limit up to the final smoke fuel limit allowing more fuel to the cylinder. In one example, in a healthy engine where the fuel or air estimate is degraded, the increased fueling may allow the exhaust flow and temperature to go up, to drive the turbine, drive the compressor, and increase airflow. In one example, if the system is degraded, the limit may sit stuck on the higher margin, allowing the engine to ramp to a higher smoke-fuel ratio and hold at that level.

The strategy in FIG. 2 is illustrated as a block diagram of the control system for limiting fueling based on smoke limits. As noted herein, approach of FIG. 2 may be programmed into instructions stored in memory of the engine controller.

At step 202, the first input to the control system includes an estimate of fuel demand (FV). In one embodiment, the estimate of fuel demand may be based on fuel injector maps. The fuel demand estimate may include inputs from other operating conditions of the system such as engine load, crank angle, engine speed, engine manifold temperature, altitude, and ambient temperature. Further, the fuel demand may be based on a notch level input.

At step 204, a second input to the controller includes a first transient smoke-fuel limit (SFL-1), which may be understood as the limit of fuel to the system given the estimate of airflow and fuel demand at the current engine operating conditions. The first transient smoke-fuel limit may be calibrated at engine speed load conditions to meet a desired emission standard. In one embodiment, the first limit may be an empirically derived limit of fuel given an amount of air described as a ratio. In one embodiment, the SFL-1 airflow may be modeled via an air speed density function with inputs from sensors detecting engine speed, engine boost pressure, and fuel injection amount (e.g., based on injection angles). Given the estimate of airflow, the amount of fuel injected to the cylinders can be limited to not exceed an estimated richness of opacity emissions. Air ingestion estimation and fuel injection estimates may be obtained by engine sensors within the system and/or determined by the controller based on commands, such as fueling commands to the fuel injectors.

At step 206, the ratio of fuel demand to the first transient smoke-fuel limit is calculated. The smoke-fuel ratio (FV/SFL-1) represents how close to the smoke-fuel limit the system is running A ratio of 1 indicates the fuel demand is at the first transient smoke-fuel limit. A smoke-fuel ratio below 1 indicates fuel demand lower than the first transient smoke-fuel limit (and thus fueling is not limited by the smoke limit).

At step 208, the smoke-fuel ratio is inputted to the bleed factor table. This look-up table compares the ratio of the modeled fuel flow to the upper limit of fuel flow, based on the current operating condition modeled airflow and upper limit of the first transient smoke-fuel limit. If the modeled fuel flow is close to the upper limit of fuel flow, the upper limit will gradually bleed to the higher upper limit (described below) to allow the engine to increase fueling.

In the example table, the FV/SFL-1 ratio is represented on the x-axis and the values range from 0.8 to 1.0. In the bleed factor table, a FV/SVL ratio of 1 is equivalent to 100% smoke-fuel ratio 1 (SFL1). An FV/SVL ratio of 0 is equivalent to 100% smoke-fuel ratio 2 (SFL2). The output of the bleed factor table is represented on the y-axis and the values range from 0 to 2. For example, when the FV/SFL input value is 0.8 the bleed factor table output is 2. When the FV/SFL input value is 1 the bleed factor table output is zero. The output of the bleed factor table is a scaling factor applied to the input. When the margin is high, faster low-pass filter recovery is forced.

Various approaches may be used to calibrate the gradual bleed mechanism. In an example, a calibration is used that enables the system response to be quick enough to provide acceptable torque/load rate performance, but slow enough that the engine is not allowed to inject excessive amounts of fuel before in-cylinder conditions are appropriate to meet smoke opacity requirements at the exhaust stack downstream. If the engine's modeled fuel flow is not close to the upper limit of fuel flow, then this bleed mechanism is not active, in order to maintain control on smoke opacity. This bleeding mechanism introduces a lever of control on time duration (at a specific torque demand, speed, and ambient condition) and the value/rate of change between the first to secondary fuel-oxygen-ratio limits. In this way, a transient bleeding that comes to the higher limit is achieved.

At step 210, the output from the bleed factor lookup table is run through a low-pass filter. The low pass filter modifies the scaled output from the bleed factor table to bring up the smoke-fuel limit gradually rather than a step change from the first limit to the final limit. The output from the low-pass filtered may range from 0 and 1. The bandwidth of the filtered output may determine how quickly the system transitions from the first limit to the final limit. In an example, a time constant that ranges between 0.5 and 2 seconds may be used. In an example, the control system as described with regard to FIG. 2 enables the smoke limit to be at the higher limit for longer than a spool-up duration of the turbocharger. The turbocharger spool-up duration may be a time-constant of the turbocharger speed response to increased flow at the current operating conditions.

Item 212 refers to the inputs and steps of weighted average function used to determine a transient bleeding up to the final smoke-fuel limit. In an example, the inputs may include the first transient smoke-fuel limit (SFL-1) and the less fuel-restrictive long transient smoke-fuel limit (SFL-2), which is weighted by the low-pass filtered bleed factor table output (210). The inputs to the weighted average function follow below.

At step 214, the weighted function includes calculating the product of the low-pass filtered bleed factor table output (210) and the first transient smoke-fuel limit (204).

Input 216 in the weighted average function is a constant (1). At step 218, the constant (1) is added to the low-pass filtered bleed factor table output. At step 220, a protection is applied, which limits the output of step 216 to an upper limit of 1 (UL=1) and a lower limit of 0 (LL=0).

Input 222 is the long transient smoke-fuel limit (or second smoke-fuel limit). It is the less fuel-restrictive smoke-fuel limit based on an estimate of how much fuel the system can consume. The inputs for the second smoke-fuel limit are the same as the first but calibrated up. The second smoke-fuel limit multiplied by the output of step 220 is the value at step 224.

At step 226, the value obtained at step 224 is added to the value obtained at step 214. This sum (226) is the final smoke-fuel limit (SFL-F) at step 228.

The bleed factor table operates in parallel with the other engine control operations, such that as the margin widens the system may bleed back down to the first limit and if the margin diminishes, again the system may bleed back up to the less fuel-restrictive upper limit again. In this way, by continuously monitoring the difference between the ratio of the injected fuel to the first smoke-fuel limit and calculating the difference into the second smoke-fuel limit, it is possible to bleed the first and second smoke-fuel limit over a duration and with a low-pass filter so that the speed of response of the limit change is coordinated with the response times of the engine and/or turbocharger system. By coordinating the response, the smoke-fuel limit may operate at the second smoke-fuel limit for at least a duration sufficiently long to allow the engine system to respond to additional fuel injection, such as turbocharger spool-up, and may be able to allow the engine to move out of fuel-limited operation even when there are substantial errors in the fuel and/or airflow estimates driving the engine fueling.

In one embodiment, there is no feedback from a smoke sensor or an oxygen sensor. Rather, the system is open loop on the air-fuel side. However, smoke sensor feedback may be used, if desired, and included in the control system as an additional feedback mechanism to control the bleeding between the first and second limits.

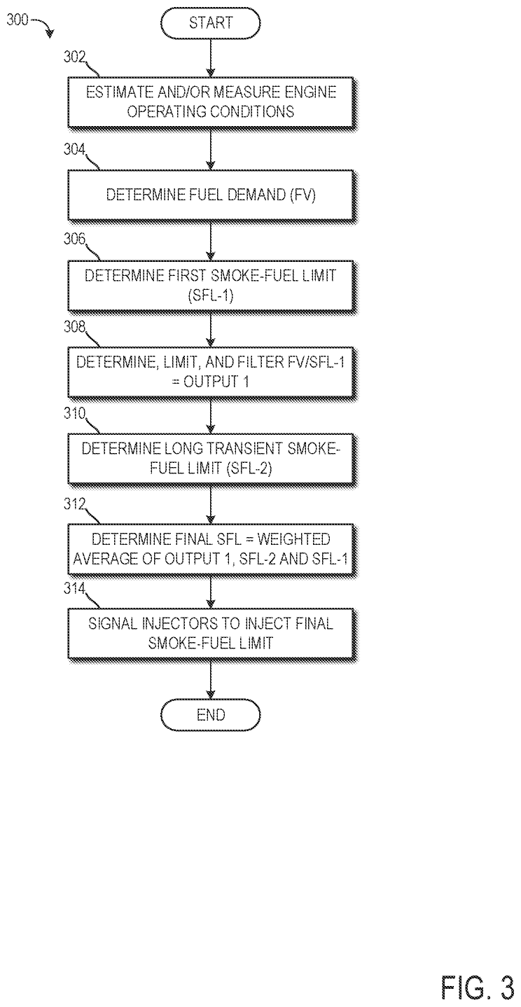

FIG. 3 shows a method 300 for balancing engine load control for opacity and load rate. The method executes the strategy provided in FIG. 2. Instructions for carrying out the method may be executed by a controller (e.g., engine controller 12 shown in FIG. 1) based on instructions stored on a memory of the controller and in conjunction with signals received from sensors of the engine system, such as the sensors described above with reference to FIG. 1. The controller may employ engine actuators of the engine system to adjust engine operation, according to the methods described below.

The method begins at step 302, where engine operating conditions are measured and/or estimated. The one or more engine operating conditions may include engine speed, engine load, engine temperature, ambient conditions (e.g., ambient temperature, pressure, and humidity), current operator torque demand, manifold pressure, manifold airflow, fuel temperature, etc. The engine operating conditions may be measured by one or more sensors communicatively coupled to the controller (e.g., pre-turbine temperature measured by the pre-turbine temperature sensors) or may be inferred based on available data (e.g., the engine temperature may be estimated from an engine coolant temperature measured by an engine coolant temperature sensor).

At step 304, the method includes determining the fuel demand (FV) of the engine. Fuel demand may be determined based on the engine operating conditions determined in step 302. Fuel demand may be estimated by the fuel injector command and/or pump maps, and continuously or intermittently relayed to the controller and stored in the controller memory.

At step 306, the method includes determining the first smoke-fuel limit (SFL-1) of the engine. The first smoke-fuel limit for a set of engine operating conditions may be calibrated according to standard methods and described in the strategy of FIG. 2. In one example, the smoke-fuel limit may be calibrated to not exceed an opacity emissions threshold based on a modeled estimate of airflow from sensors detecting engine speed, engine boost pressure, and injection angle and an estimate of fuel demand from the fuel injector pumps. In one example, the first smoke fuel limit is calibrated to a threshold not to exceed an average 10% opacity over 6 minutes. In one example, to meet a 10% opacity emissions limit for a given airflow estimate, the fuel demand may not exceed 2 milliliters (mL) per second (s).

At step 308, the method includes determining the ratio of fuel demand to the first smoke-fuel limit. This difference between maximum first fuel allowance and estimated fuel demand is the margin that represents how close to the smoke-fuel limit the system is running. In one example, the first smoke-fuel limit for a given airflow caps fuel demand at 2 mL/s and estimated current fuel demand is 2 mL/s, such that FV/SFL-1=1. As described in FIG. 2, the FV/SFL-1 ratio is looked up in the bleed factor table. When FV/SFL-1=1, the low difference between fuel demand and the first smoke-fuel limit (100% SFL-1) transitions the system toward the long transient smoke-fuel limit. The bleed factor table returns OUTPUT 1=0 when FV/SFL-1=1. The output value of the bleed factor table is passed through a low-pass filter. In one example, the output of the low pass filter determines the rate of transition between SFL-1 and SFL-2. In one example, a fuel demand estimate may be calibrated appropriately at one altitude and at a second higher altitude struggle to maintain speed for a given load. In another example, a fuel demand estimate may be impacted by the health of the engine, such as pressure loss in the fuel system may increase fuel demand.

At step 310, the method includes determining the long transient smoke-fuel limit. The long transient smoke-fuel limit may be calibrated for a set of engine operating conditions according to standard methods and as described above for the first smoke-fuel limit but scaled up to allow less restrictive fueling. In one example, the long transient smoke fuel limit is calibrated to meet a 10% opacity emissions limit for a given airflow estimate and the fuel demand may not exceed 4 mL/s.

At step 312, the method includes determining the final smoke fuel limit. The final smoke fuel limit is the weighted average of the long transient smoke-fuel limit and the first smoke-fuel limit. In one example, the weighted average of the long transient smoke-fuel limit and the first smoke fuel limit results in an increase of fuel demand to 3.5 mL/s.

At step 314, the method includes signaling the injectors to increase fuel injection up to the final smoke fuel limit at the rate determined by the filtered output of the bleed factor table (310). In one example, the controller may determine a control signal to send to the fuel injector to increase fuel injection up to the final smoke fuel limit of 3.5 mL/s.

Following the signal to the fuel injectors, the controller may continuously monitor the difference between fuel demand and the first limit, look up the ratio in the bleed factor table, determine if additional adjustments may improve engine performance, and further limit fuel injection as described above. In one example, during at least an operating condition, following detection of the system sitting on the first smoke-fuel limit, the controller signals increased fuel injection following the method described above. The increased fuel results in the engine turbine spooling up and airflow increasing. The first smoke-fuel limit for the system may increase given the change in engine operating conditions. The controller continues to monitor the margin and finds the smoke-fuel ratio is 0.5. The wide margin results in the system maintaining fuel demand at the increased first smoke-fuel limit and the system meeting the opacity emission standard.

In another example, following detection of the engine system sitting on the first smoke-fuel limit for a set of operating conditions, the controller signals increased fuel injection following the method described above. The increased fuel does not increase airflow and therefore no change in engine operating conditions at the higher smoke-fuel limit. The controller continues to monitor the margin and finds the smoke-fuel ratio at or near 1. In this case, where an element of the engine system may be malfunctioning, the system may maintain fuel demand at the higher long-transient smoke-fuel limit and increase no further.

By continuously monitoring the ratio of the injected fuel to the first smoke-fuel limit and calculating the low-pass filtered difference into the second smoke-fuel limit, the fueling increase amount and the speed of limit change may be coordinated with the response times of the engine and/or turbocharger. Increased fueling to a healthy engine may enable temporarily increased engine torque so that engine speed and/or turbocharger speed may catch up to a level where there is sufficient engine airflow so that fuel injection is not smoke limited. In this way, an engine may be able to move out of the fuel-limited operation even when there are errors in the fuel and/or airflow estimates driving the smoke-fuel limit.

The disclosure also provides support for a method for controlling an engine, the method comprising: injecting fuel to the engine, and during at least an operating condition, limiting injected fuel based on engine airflow to a smoke-fuel limit, the smoke-fuel limit transiently adjusted from a first smoke-fuel limit to a second smoke-fuel limit based on a duration operating at the smoke-fuel limit. In a first example of the method, the method further comprises: during another operating condition, not limiting fuel injection based on the engine airflow by the smoke-fuel limit. In a second example of the method, optionally including the first example, the duration is a time duration. In a third example of the method, optionally including one or both of the first and second examples, the duration is a crank-angle duration. In a fourth example of the method, optionally including one or more or each of the first through third examples, limiting the injected fuel is based on an estimated engine airflow and an estimated fuel injection amount to the engine. In a fifth example of the method, optionally including one or more or each of the first through fourth examples, the adjustment from the first smoke-fuel limit to the second smoke-fuel limit is based on a low-pass filtered difference between a ratio of the injected fuel to the first smoke-fuel limit. In a sixth example of the method, optionally including one or more or each of the first through fifth examples, the adjustment is further based on the low-pass filtered difference multiplied by the first smoke-fuel limit. In a seventh example of the method, optionally including one or more or each of the first through sixth examples, the adjustment is further based on a sum of a constant of 1 and the low-pass filtered difference lower limited to zero and upper limited to one. In an eighth example of the method, optionally including one or more or each of the first through seventh examples, the engine is a diesel engine operating in a locomotive, and an engine control system adjusting the injected fuel does not include a smoke sensor. In a ninth example of the method, optionally including one or more or each of the first through eighth examples, the method may include boosting engine intake air with a turbocharger system, wherein the smoke-fuel limit operates at the second smoke-fuel limit for at least a duration longer than a turbocharger spool-up duration.

The disclosure provides an engine system that includes: an internal combustion engine having a fuel injector and a control system. The control system may initiate the injection fuel to the internal combustion engine from the fuel injector, and during at least an operating condition, limit injected fuel based on engine airflow to a smoke-fuel limit, the smoke-fuel limit transiently adjusted from a first smoke-fuel limit to a second smoke-fuel limit based on a duration operating at the smoke-fuel limit. In a first example of the system, the control system may initiate: during another operating condition, injecting fuel based on engine airflow, the fuel injection not limited by the smoke-fuel limit, and wherein the injected fuel is one or more of, or a combination of, diesel fuel, bio fuel, ammonia, natural gas, and gasoline. In a second example of the system, optionally including the first example, the adjustment from the first smoke-fuel limit to the second smoke-fuel limit is based on a low-pass filtered difference between a ratio of the injected fuel to the first smoke-fuel limit. In a third example of the system, optionally including one or both of the first and second examples, the adjustment is further based on the low-pass filtered difference multiplied by the first smoke-fuel limit, and based on a sum of a constant of 1 and the low-pass filtered difference lower limited to zero and upper limited to one. In a fourth example of the system, optionally including one or more or each of the first through third examples, the internal combustion engine is a diesel engine including an engine exhaust, and wherein the engine system does not include a smoke sensor in the engine exhaust. In a fifth example of the system, optionally including one or more or each of the first through fourth examples, the system further comprises: a turbocharger coupled to the engine, wherein the smoke-fuel limit operates at the second smoke-fuel limit for at least a duration longer than a turbocharger spool-up duration.

The disclosure provides an engine system having a diesel-fueled internal combustion engine having a common rail fuel injector and an exhaust system without a smoke sensor, and a control system. The control system can initiate injection of fuel to the engine from the common rail fuel injector into a cylinder of the engine, where an amount of fuel to be injected is based on an estimated engine airflow, and where the control system estimates the amount of fuel actually injected, and further limit injected fuel based on the estimated fuel actually injected based on a smoke-fuel limit, the smoke-fuel limit only transiently adjusted from a first smoke-fuel limit to a second smoke-fuel limit based on a duration operating at the smoke-fuel limit. In a first example of the system, the engine is coupled in a vehicle. In a second example of the system, optionally including the first example, the adjustment from the first smoke-fuel limit to the second smoke-fuel limit is based on a low-pass filtered difference between a ratio of the injected fuel to the first smoke-fuel limit. In a third example of the system, optionally including one or both of the first and second examples, the adjustment is further based on the low-pass filtered difference multiplied by the first smoke-fuel limit, and based on a sum of a constant of 1 and the low-pass filtered difference lower limited to zero and upper limited to one.

In one embodiment, the control system, or controller, may have a local data collection system deployed and may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. The tasks may be machine learning problems such as classification, regression, clustering, density estimation, dimensionality reduction, anomaly detection, and the like. In examples, machine learning may include a plurality of mathematical and statistical techniques. The machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components are restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and control, behavior analytics, and the like.

In one embodiment, the controller may include a policy engine that may apply one or more policies. These policies may be based at least in part on characteristics of a given item of equipment or environment. With respect to control policies, a neural network can receive input of a number of environmental and task-related parameters. The neural network can be trained to generate an output based on these inputs, with the output representing an action or sequence of actions that the engine system should take. This may be useful for balancing competing constraints on the engine. During operation of one embodiment, a determination can occur by processing the inputs through the parameters of the neural network to generate a value at the output node designating that action as the desired action. This action may translate into a signal that causes the engine to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes. These may be weighed relative to each other.

As used herein, an element or step recited in the singular and preceded with the word “a” or “an” should be understood as not excluding plural of said elements or steps, unless such exclusion is explicitly stated. Furthermore, references to “one embodiment” of the invention do not exclude the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method for controlling an engine, the method comprising:
injecting fuel to the engine; and
during a first operating condition, limiting injected fuel based at least in part on an estimated engine airflow up to a determined smoke-fuel limit, the smoke-fuel limit being transiently adjusted from a first smoke-fuel limit to a second smoke-fuel limit based on a duration of operating at the smoke-fuel limit, the engine airflow distinct from a torque demand.

2. The method of claim 1, further comprising, during a second operating condition, not limiting fuel injection based on the estimated engine airflow by the smoke-fuel limit.

3. The method of claim 1, wherein the duration is a time duration.

4. The method of claim 1, wherein the duration is a crank-angle duration.

5. The method of claim 1, wherein limiting the injected fuel is further based on an estimated fuel injection amount to the engine.

6. The method of claim 1, wherein the adjustment from the first smoke-fuel limit to the second smoke-fuel limit is based on: determining a ratio of the injected fuel to the first smoke-fuel limit, low-pass filtering the ratio, and then bleeding the low-pass filtered ratio to the second smoke-fuel limit.

7. The method of claim 6, wherein the adjustment is further based on the low-pass filtered difference multiplied by the first smoke-fuel limit.

8. The method of claim 7, wherein the adjustment is further based on a sum of a constant of 1 and the low-pass filtered difference lower limited to zero and upper limited to one.

9. The method of claim 1, wherein the engine is a diesel engine operating in a locomotive, and wherein an engine control system adjusting the injected fuel does not include or communicate with a smoke sensor.

10. The method of claim 1, further comprising boosting engine intake air with a turbocharger system, and the smoke-fuel limit operates at the second smoke-fuel limit for at least a duration longer than a turbocharger spool-up duration, where the turbocharger spool-up duration is a time-constant of the turbocharger speed response to increased flow at the current operating conditions.

11. An engine system, comprising:
an internal combustion engine having a fuel injector; and
a control system configured to:
inject fuel to the internal combustion engine from the fuel injector; and
during at least an operating condition, limit injected fuel based on estimated engine airflow to a smoke-fuel limit, the smoke-fuel limit transiently adjusted from a first smoke-fuel limit to a second smoke-fuel limit based on a duration operating at the smoke-fuel limit.

12. The system of claim 11, wherein the control system is further configured to: during another operating condition, injecting fuel based on estimated engine airflow, the fuel injection not limited by the smoke-fuel limit, and wherein the injected fuel is one or more of, or a combination of, diesel fuel, bio fuel, ammonia, natural gas, and gasoline.

13. The system of claim 12, wherein the adjustment from the first smoke-fuel limit to the second smoke-fuel limit is based on a low-pass filtered difference between a ratio of the injected fuel to the first smoke-fuel limit.

14. The system of claim 13, wherein the adjustment is further based on the low-pass filtered difference multiplied by the first smoke-fuel limit, and based on a sum of a constant of 1 and the low-pass filtered difference lower limited to zero and upper limited to one.

15. The system of claim 14, wherein the internal combustion engine is a diesel engine including an engine exhaust, and wherein the engine system does not include a smoke sensor in the engine exhaust.

16. The system of claim 15, further comprising a turbocharger coupled to the engine, wherein the smoke-fuel limit operates at the second smoke-fuel limit for at least a duration longer than a turbocharger spool-up duration, where the turbocharger spool-up duration is a time-constant of the turbocharger speed response to increased flow at the current operating conditions.

17. An engine system, comprising:
a diesel-fueled internal combustion engine having a common rail fuel injector and an exhaust system without a smoke sensor; and
a control system configured to:
inject fuel to the engine from the common rail fuel injector into a cylinder of the engine, where an amount of fuel to be injected is based on an estimated engine airflow, and where the control system estimates the amount of fuel actually injected, and further limit injected fuel based on the estimated fuel actually injected based on a smoke-fuel limit, the smoke-fuel limit only transiently adjusted from a first smoke-fuel limit to a second smoke-fuel limit based on a duration operating at the smoke-fuel limit.

18. The system of claim 17, wherein the engine is coupled in a vehicle.

19. The system of claim 17, wherein the adjustment from the first smoke-fuel limit to the second smoke-fuel limit is based on a low-pass filtered difference between a ratio of the injected fuel to the first smoke-fuel limit.

20. The system of claim 19, wherein the adjustment further is based on the low-pass filtered difference multiplied by the first smoke-fuel limit and is based on a sum of a constant of 1 and the low-pass filtered difference lower limited to zero and upper limited to one.
